(19) United States
(12) Patent Application Publication
(10) Pub. No.: US 2014/0205108 A1
(43) Pub. Date: Jul. 24, 2014

(54) Necklace-Style Wireless Audio Headset

(71) Applicant: Patrick R. TRIATO, Portland, OR (US)

(72) Inventor: Patrick R. TRIATO, Portland, OR (US)

(21) Appl. No.: 13/746,259

(22) Filed: Jan. 21, 2013

(51) Int. Cl. H04R 1/10

(52) U.S. Cl. CPC H04R 1/1091
USPC 381/74

(57) ABSTRACT

A wireless audio headset configured to be worn as a pendant necklace, with wireless receiver, audio amplifier, controls, display and power source built into the pendant, the pendant suspended about the user's neck by wires that carry audio signals from the pendant to in-ear drivers; the pendant further containing storage compartments for storing the earphones when not in use.

### CONTINUITY AND CLAIM OF PRIORITY

This is an original U.S. patent application.

### FIELD

The invention relates to portable wireless audio systems. More specifically, the invention relates to wireless headphone systems with integrated earpiece storage provisions.

### BACKGROUND

Portable audio playback systems have developed from fragile, low-fidelity devices and heavy, power-hungry systems that are only nominally portable; through small, monophonic transistor radios with crude earplug headsets; to Walkman®-style devices to reproduce (and often to record) sounds on various media. Presently, tiny, power-efficient digital recorders and players can store weeks' worth of audio and video, and can play continuously for dozens of hours.

To deliver reproduced sound to a listener, portable audio systems often rely on headsets or headphones, which are themselves objects of active development and refinement. Many conflicting requirements affect the design of headsets. It is difficult to provide excellent sound quality, durability, convenience of use, ease of storage, long playback duration, affordability and other desirable characteristics in a single product. Thus, headset designs represent a compromise among competing goals. In this environment, products that target unexplored areas of the design space may find commercial acceptance and may be of significant value in the field.

### SUMMARY

A wireless audio headset in a pendant-necklace form includes a power supply, a wireless receiver and audio processing circuitry in a pendant module. The module has two flexible cables extending therefrom to in-ear audio drivers (speakers, “earbuds”). The cables may be joined together by a clasp, subparts of which are attached to each of the cables, so that the pendant may be suspended from the user's neck by the cables. The pendant includes one or more storage compartments or receptacles to hold the in-ear audio drivers when the device is not in use. Other configurations and variations are also described and claimed.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a model wearing an embodiment of the invention.

FIG. 2 shows another view of an embodiment without a user.

FIGS. 3 and 4 show embodiments with earphones stored in the necklace pendant.

FIG. 5 is a hybrid system-block/physical-feature diagram showing some common elements of embodiments.

FIGS. 6, 7A and 7B show details of clasps that may be used in an embodiment.

### DETAILED DESCRIPTION

Embodiments of the invention are wireless headsets configured to be worn as necklaces, with storage for earphones built into a necklace pendant so that the embodiment can be worn as an ordinary necklace when not in use as an audio playback monitor.

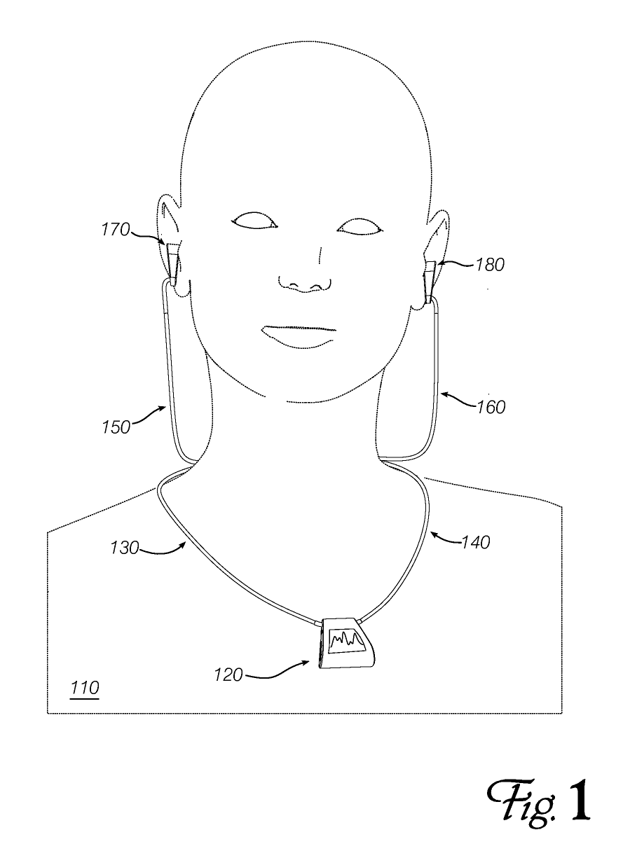

FIG. 1 shows a model 110 wearing an embodiment of the invention. The wireless headset includes a pendant 120, which is suspended about the wearer's neck by wires 130 and 140. These wires are joined behind the wearer's neck by a clasp (not visible in this view). Wires 130 and 140 extend beyond the clasp as shown at 150 and 160, respectively; ultimately, the wires terminate at right and left earphones 170 and 180. Note that the headset is “wireless” in the sense that audio signals are transmitted wirelessly from an audio player to a receiver in the embodiment (typically, the receiver will be located in the pendant portion of the embodiment). Wires carry the audio signal from the pendant to the earphones, and also suspend the pendant from the user's neck. In some embodiments, the pendant also contains a wireless transmitter to send commands (such as play/pause, fast forward, replay, and so on) to the audio player.

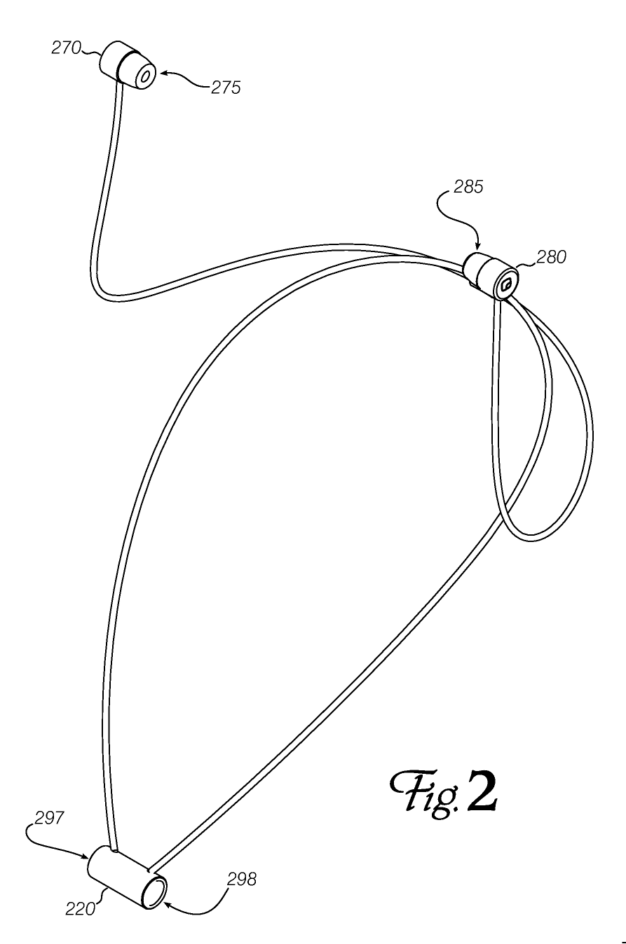

FIG. 2 shows another view of an embodiment, with the earphones 270, 280 extracted from their storage locations 297, 298 in the pendant 220 and raised near a position suitable for inserting into a user's ears. Earphones of this form are often called “earbuds,” and are designed to be wedged into the user's outer ears and/or ear canals. Earbuds sometimes include a resilient, compressible pad 275, 285 that can be squeezed or twisted prior to insertion, and which expands to block outside sound and to help hold the earphone in the user's ear.

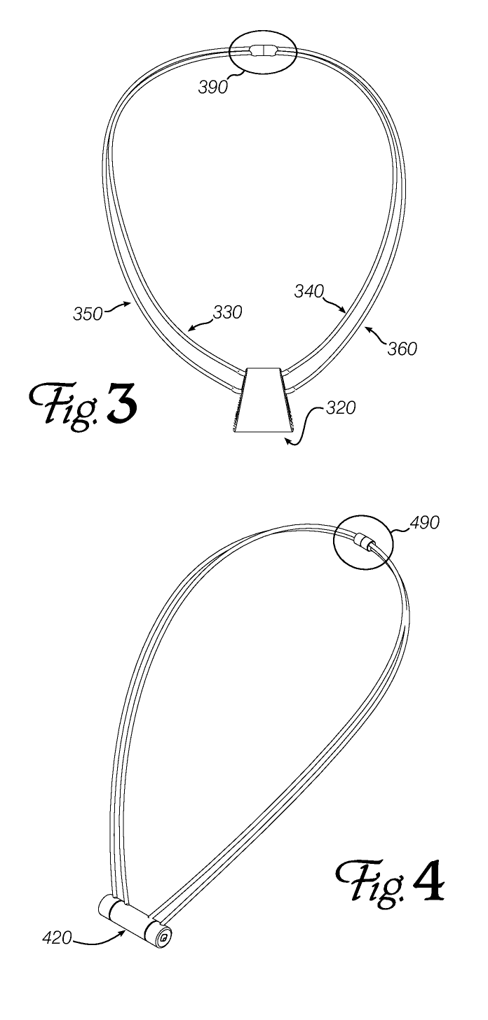

FIGS. 3 and 4 show two different embodiments, with the earphones or earbuds stored in the pendant. In this configuration, an embodiment looks much like an ordinary necklace, with a pendant (320, 420) suspended on each side by two wires (e.g., 330/340 and 350/360). In an embodiment, these two wires are actually a single wire that is bent or folded in half at the clasp (390, 490), as described in greater detail below.

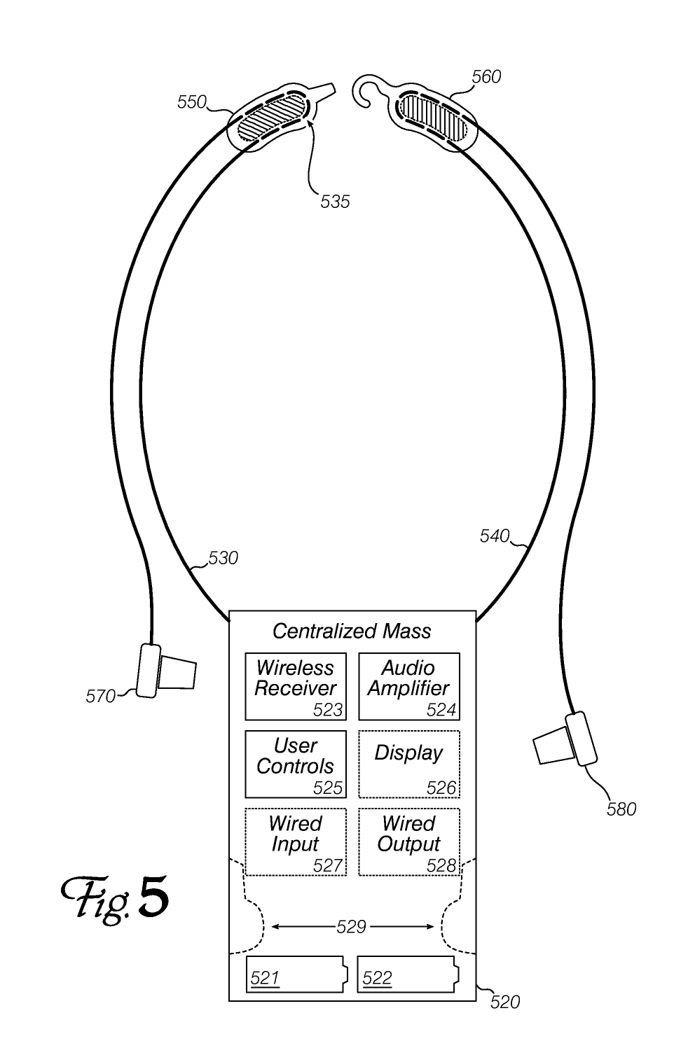

FIG. 5 is a hybrid block system diagram and representative physical model of an embodiment. The pendant portion of the embodiment 520 usually includes a number of functional elements, including a power source such as batteries 521, 522; a wireless receiver 523 (or a transceiver, as discussed above); an audio amplifier 524; and one or more user controls 525. For example, controls may be provided to turn the embodiment on and off; to adjust the audio volume; or to send control signals wirelessly to an audio player that is transmitting sound to the wireless receiver. Many contemporary audio players transmit audio signals wirelessly according to the Bluetooth® data-exchange standard. Thus, in a preferred embodiment, wireless receiver 523 is a Bluetooth® receiver (transceiver), which acts to receive audio signals for reproduction, and to transmit control signals to the audio player.

An embodiment may also include a display 526, which may be as simple as an indicator LED to show that the unit is powered on, or as sophisticated as a two-dimensional graphical display to show system state, to provide a richer user interface, or to display abstract designs and patterns. For example, an embodiment with a graphical display may show sound volume and frequency by means of pulsing or gyrating colors and brightness.

Some embodiments may include a wired input 527, such as a 3.5 mm stereo jack, to accept audio signals provided by a cable; and/or an output jack 528 such as a 3.5 mm stereo jack, to send an audio signal to another unit. Thus, one user of an embodiment may connect her pendant to another user's so that both can listen to the same audio program.

The pendant portion of the embodiment includes physical storage compartments 529, which are suitable for accepting and securing the earphones of the embodiment when not in use.

Flexible, supple wires or cables 530 and 540 connect the pendant to earphones 570 and 580. These wires carry the audio signals from audio amplifier 524, but they also support the pendant as a necklace. Each wire extends to a locking, turnaround clasp structure 550, 560, and then returns to its corresponding earphone (note the “U” turn of wire 530 indicated at 535). The clasp halves 550, 560 may be identical or complementary. In this Figure, a hook and loop clasp is shown, but pairs of mating hooks, twist-lock barrels, or magnetic clasps may also be used. Each clasp half should lock or hold or prevent the wire from sliding freely through it, so that the length of the pendant-suspending wire and the wire from the clasp half to the earphone do not change inadvertently. However, to adjust the lengths of the two portions of the wire, it is preferable that the lock mechanism be easily defeated and then re-engaged once the wires are adjusted to suit the user.

The pendant portion of an embodiment forms a centralized mass that helps hold the unit in place about the wearer's neck, and helps keep the ends of the headphone wires at their respective clasps from moving about. (Motion and tugging on the headphone wires can pull the earphones out of the user's ears, which is annoying and inconvenient.) The clasp must be strong enough to resist the tension force of the pendant's mass acting through the suspension wires.

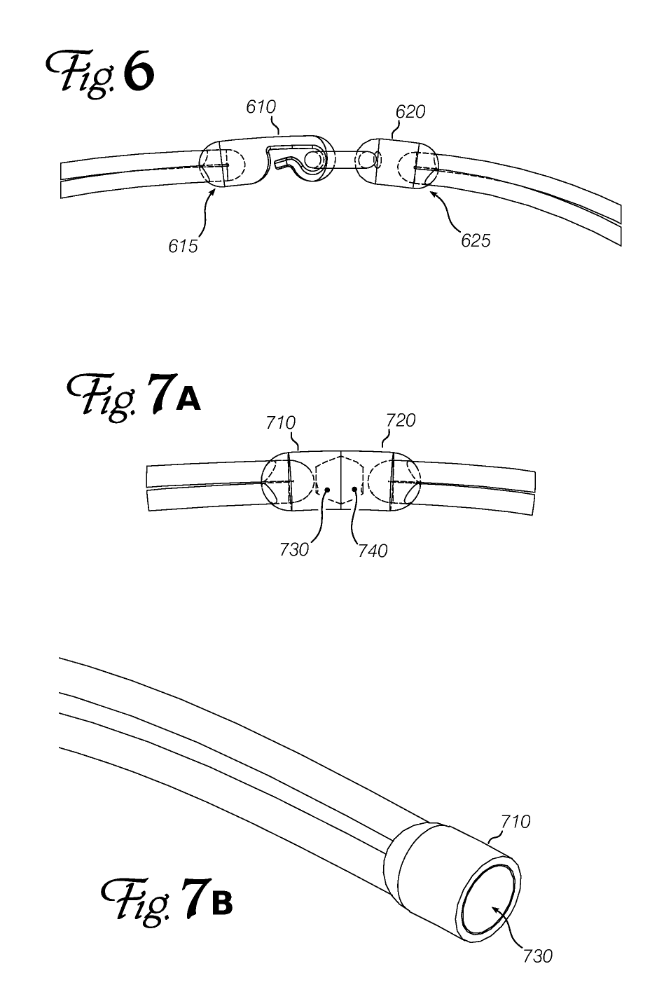

FIG. 6 shows a detail of a hook-and-loop clasp of an embodiment of the invention. Hook 610 holds a first of the embodiment's wires, which makes a U-turn as shown at 615. Loop portion 620 hold's the embodiment's other wire, which also makes a U-turn shown at 625.

FIG. 7A shows a detail of a magnetic clasp, with two substantially identical clasp halves 710 and 720. However, the clasp's magnets 730, 740 must be oriented so that the halves attract one another. FIG. 7B shows an enlarged detail of clasp-half 710, including one face of magnet 730.

The features and characteristics of the present invention have been described largely by reference to specific examples and in terms of particular configurations of components. However, those of skill in the art will recognize that self-storing wireless audio headsets can also be arranged differently than herein described. Such alternate arrangements and variations are understood to be captured according to the following claims.

I claim:

1. An audio headset comprising:
a pendant containing a power source, a wireless receiver and an audio processing circuit;
two separate, flexible cables extending from the pendant, each cable connecting the pendant to an audio transducer, said audio transducers suited for securing in a left or a right ear of a user; and
a clasp for securing the two separate, flexible cables together behind a neck of the user so that the pendant is suspended about the user's neck by the flexible cables, wherein
the pendant includes storage locations to accept the audio transducers when the headset is not in use.

2. The audio headset of claim 1, further comprising at least one user control.

3. The audio headset of claim 2 wherein the at least one user control is a power control.

4. The audio headset of claim 2 wherein the at least one user control is a volume control.

5. The audio headset of claim 2 wherein the at least one user control is to control a remote audio player

6. The audio headset of claim 1, further comprising an input to accept an audio signal via a wired connection.

7. The audio headset of claim 1, further comprising an output to emit an audio signal via a wired connection.

8. The audio headset of claim 1, further comprising an indicator display.

9. The audio headset of claim 8 wherein the indicator display is an LED.

10. The audio headset of claim 8 wherein the indicator display is a two-dimensional graphical display.

11. A necklace-style wireless audio headset comprising:
a centralized mass coupled to two wires, each of said wires leading to an in-ear audio speaker;
two locking wire turnaround fixtures, one coupled to each of the two wires, said turnaround fixtures adapted to reversibly connect to each other securely enough to resist a tension force exerted by the centralized mass acting on the connected turnaround fixtures through the two wires;
a power supply;
a receiver to receive a wireless signal and extract an audio signal therefrom;
an audio amplifier to amplify the audio signal for delivery to the in-ear audio speakers; and
at least one integrated storage compartment suitable for storing the in-ear audio speakers.

12. The necklace-style wireless audio headset of claim 11, further comprising:
user controls for activating the headset and for adjusting a volume of the headset.

13. The necklace-style wireless audio headset of claim 11, further comprising:
an audio input jack for receiving an audio signal via a wired connection.

14. The necklace-style wireless audio headset of claim 11, further comprising:
an audio output jack for emitting an audio signal via a wired connection.

15. The necklace-style wireless audio headset of claim 11, further comprising a graphical display.

16. A Bluetooth® wireless audio headset comprising:
a central pendant module including a Bluetooth® transceiver, an audio amplifier, a user interface control and a battery;
two wires connecting the central pendant module to two earbuds; and
two necklace-clasp halves, one attached to each of the two wires so that the pendant can be suspended from a user's neck by the two wires, wherein the central pendant module contains earbud receptacles to securely store the earbuds when they are not in use.

17. The Bluetooth® wireless audio headset of claim 16, further comprising:
a two-dimensional graphical display panel.

18. The Bluetooth® wireless audio headset of claim 16 wherein the battery is rechargeable.
